(19) United States
(12) Patent Application Publication
(10) Pub. No.: US 2015/0088485 A1
(43) Pub. Date: Mar. 26, 2015

(54) COMPUTERIZED SYSTEM FOR INTER-LANGUAGE COMMUNICATION

(71) Applicants: Moayad Alhabobi, Dearborn Heights, MI (US); Mounir Alhabboubi, Dearborn, MI (US)

(72) Inventors: Moayad Alhabobi, Dearborn Heights, MI (US); Mounir Alhabboubi, Dearborn, MI (US)

(21) Appl. No.: 14/494,888

(22) Filed: Sep. 24, 2014

Related U.S. Application Data
(60) Provisional application No. 61/881,685, filed on Sep. 24, 2013.

(51) Int. Cl. G06F 17/28; H04L 29/06

(52) U.S. Cl. CPC G06F 17/289; H04L 65/403
USPC 704/2

(57) ABSTRACT

A system of communication is disclosed providing for real-time communication between users communicating in different languages. A computerized processor can operate a communication program according to the disclosed system. The program can be configured to receive a first communication in a first language from a first user, translate the first communication into a second language in real time, provide the translated first communication to a second user, receive a second communication in the second language from the second user, translate the second communication into the first language in real time, and provide the translated second communication to the first user.

### CROSS REFERENCE TO RELATED APPLICATIONS

This disclosure claims the benefit of U.S. Provisional Application No. 61/881,685 filed on Sep. 24, 2013 which is hereby incorporated by reference

### TECHNICAL FIELD

This disclosure is related to a computerized system for inter-language communication by computer, each communicant in his or her preferred language. In particular, the present disclosure includes a computerized devices operating a chat room, the devices networked to a server, where programming translates communications in real time.

### BACKGROUND

The statements in this section merely provide background information related to the present disclosure. Accordingly, such statements are not intended to constitute an admission of prior art.

People all over the world use Internet chat rooms for many diverse purposes. The topics discussed or “chatted” about can vary from political topics, sports, cooking, automotive repair, and even how to stop a baby from crying. A chat room can be just two people or it can be dozens to hundreds. They can all be “chatting” at once, or over an extended period of time, even months. Users can access it from a desk top computer, a laptop, a smart phone, or other similar devices. Despite the diversity of methods of using a chat room and the topics discussed, they all have a limitation—the users must converse or chat in the same language. If a chat topic begins in English and someone then adds a “thread” in Spanish, it will turn into two parallel “threads” that are side-by-side but each only responding to comments in comments in the same language. If a comment is made in Spanish, a commenter who only understands English will not understand the posting and will ignore it. Even if someone is bilingual, and can respond, many can then not understand the response.

Communication can similarly take place between an online company and a consumer. For example, if a customer is viewing a page for more than a threshold time span, computerized systems are utilized to generate a chat request between the consumer and a live agent for the company running the website. However, the agent must be extensively trained in the language and social customs of the consumers in a target country. For example, a company run in India or China may want to communicate with consumers in Europe or the United States, and the quality of the interaction between the agents of the company and the consumers may positively or negatively impact the sales and reputation of the company.

A chat room can also be set up as an educational tool. An instructor can lead a classroom and pupils can observe and even ask questions. They can watch short video clips of the instructor's choosing and then ask questions to obtain clarification. Once again, a major drawback is that everyone must converse in the same language.

This restriction limits the free-flow of ideas, especially amongst scientists and others in academia who may otherwise collaborate on the same research project.

### SUMMARY

A system of communication is disclosed providing for real-time communication between users communicating different languages. A computerized processor can operate a communication program according to the disclosed system. The program can be configured to receive a first communication in a first language from a first user, translate the first communication into a second language in real time, provide the translated first communication to a second user receive a second communication in the second language from the second user, translate the second communication into the first language in real time, and provide the translated second communication to the first user.

### BRIEF DESCRIPTION OF THE DRAWINGS

One or more embodiments will now be described, by way of example, with reference to the accompanying drawings, in which:

FIG. 1A illustrates an exemplary portable computerized device in communication with a chat room server via a network, in accordance with the present disclosure;

FIG. 1B illustrates another example of the portable computerized device of FIG. 1A in communication with a chat room server via a network, in accordance with the present disclosure;

FIG. 2 illustrates an exemplary chat room web page displayed on a desktop monitor in communication with a chat room server via a network, in accordance with the present disclosure;

FIG. 3 is a schematic illustrating exemplary components of the portable computerized device of FIGS. 1A and 1B, in accordance with the present disclosure;

FIG. 4 is a schematic illustrating exemplary components of an automatically translating chat room server, in accordance with the present disclosure;

FIG. 5 is a flowchart illustrating an exemplary process for a computerized system for inter-language chatting, in accordance with the present disclosure; and

FIG. 6 illustrates an exemplary display screen providing a venue for a user to watch a synchronized display of a movie with other users, providing translated chat messages during the movie, in accordance with the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or processes have not been described in detail in order to avoid obscuring the present disclosure.

An individual can enter a chat room that is presently being used by a multitude of people of differing spoken languages. What appears on the screen to him or her is a multitude of different foreign languages that he or she cannot understand. He or she can either respond to the most recent posting of a language that he or she understands. However, much of the communication in such a chat room would be lost for lack of translation.

A computerized system for translating communication in real time is disclosed. In one exemplary embodiment, an auto-detect feature of the chat-room software will detect what language a person activating the software is using and from then on will automatically translate all other user's postings into that user's native language. As an alternative, the user can choose from a menu which language he or she prefers and then all postings will also be automatically translated into his or her preferred language.

The disclosed system provides that when a person speaks, enters text, or otherwise shares information in his or her language, the information can be translated in real time to other receivers by their own languages. Any person can enjoy use of the disclosed system as a professional network or as a social network. The system can be used for fun, education, professional advancement, business, or any other purposes. Video, pictures, and other content can be shared with other users simultaneously in many different languages. The system can be for any users, including professionals and casual users. Such uses can be in the abstract as a stand-alone system. In the alternative, the included system can be used with other services such as Facebook® and Linked-In®.

When the user types something and it appears on his or her screen, while it appears in his or her chosen language, it meanwhile has been automatically translated into the preferred language of other users. The written language can be in Latin text form, Middle Eastern script, Asian characters such as Chinese or Japanese, and sign language.

In one embodiment, instead of text or script appearing on the user's screen, audio can be either substituted or be heard in addition, via a text to speech converter.

This disclosure can bring together mono-lingual students in a virtual classrooms with a single instructor. The instructor or professor can talk on one language in real time and his or her words can be translated in real time into the language of the student. The student can choose to either hear the professor or read the words, or both. If he or she were to ask a question, or any of his or her classmates ask a question, everyone can understand both the question and the reply, even though all three may be mono-lingual and speak different languages.

In one embodiment, if an instructor needs to show a virtual classroom a video clip, all audio will be automatically translated into the language of the user, just as the instructor's voice or text. The class can discuss the video or photographs afterwards, each in his or her own language with all understanding.

In one embodiment, the chat room system has a feature that allows a user to include their gender, inflexion, and emotion when using the speech-to-speech translation feature.

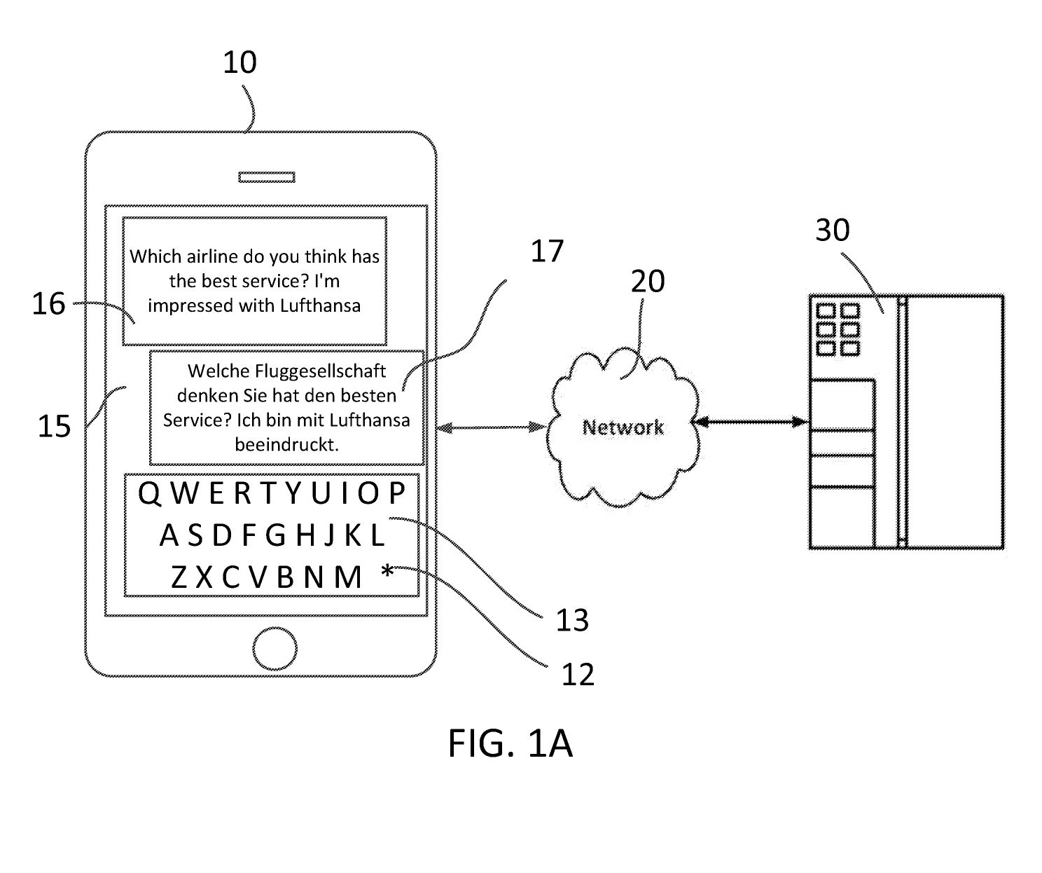

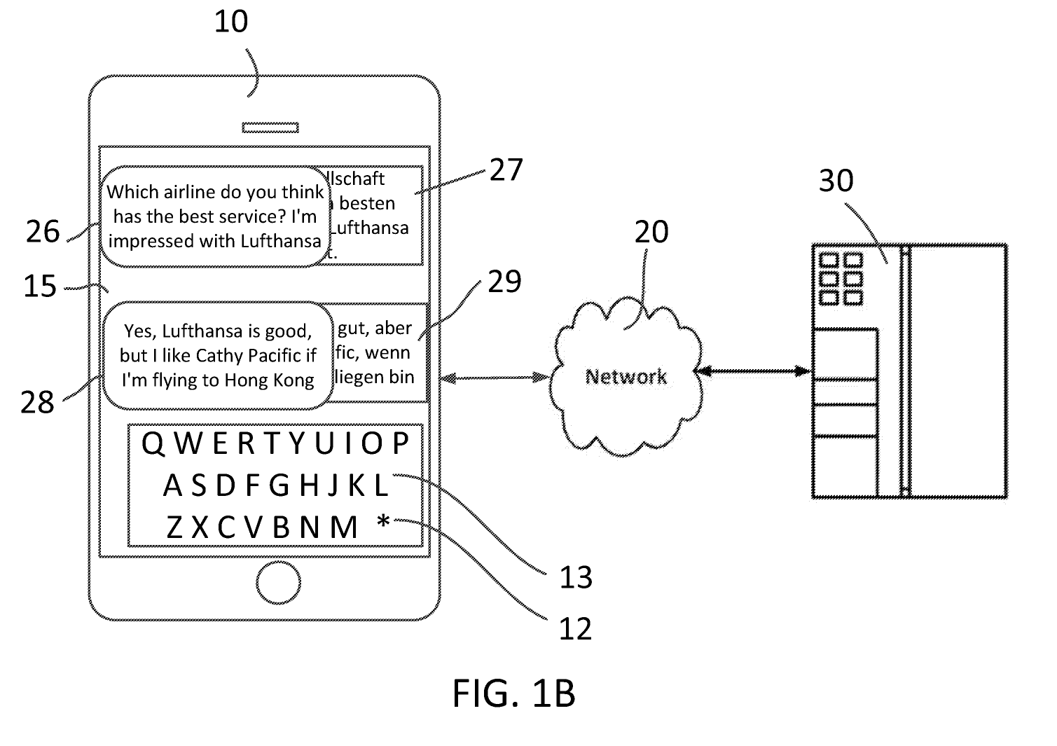

Referring now to the drawings, wherein the showings are for the purpose of illustrating certain exemplary embodiments only and not for the purpose of limiting the same, FIG. 1A illustrates an exemplary portable computerized device in communication with a chat room server via a network. In some embodiments, as shown in the illustrative example, the portable computerized device 10 is displaying a graphical user interface (GUI) 15 configured as a touch screen device that is displaying the “chat room screen” text 16 and “chat room screen” text 17. Device 10 and server 30 communicate through wireless network 20. GUI 15 also has a qwerty keyboard 13 that can be used to add text to the GUI box such as “chat room screen” text 16. Speech-to-text icon 12 is chosen to convert the spoken word into text via software that in on the portable computerized device 10.

FIG. 1B illustrates an exemplary portable computerized device in communication with a chat room server via a network. In some embodiments, as shown in the illustrative example, the portable computerized device 10 is displaying a graphical user interface (GUI) 15 configured as a touch screen device that is displaying the “chat room screen” text 26 and “chat room screen” text 28. Underneath “chat room screen” text 26 is “chat room screen” text 27, which is the original non-translated text of “chat room screen” text 26. If the user prefers this to the translated version, then by clicking on it, it will be on top and all subsequent text in that language will also be on top. “Chat room screen” text 29 is also the non-translated text of “chat room screen” text 28. Device 10 and server 30 communicate through wireless network 20. GUI 15 also has a standard keyboard 13 that can be used to add text to the GUI box such as “chat room screen” text 26. Speech-to-text icon 12 is chosen to convert the spoken word into text via software that in on the portable computerized device 10.

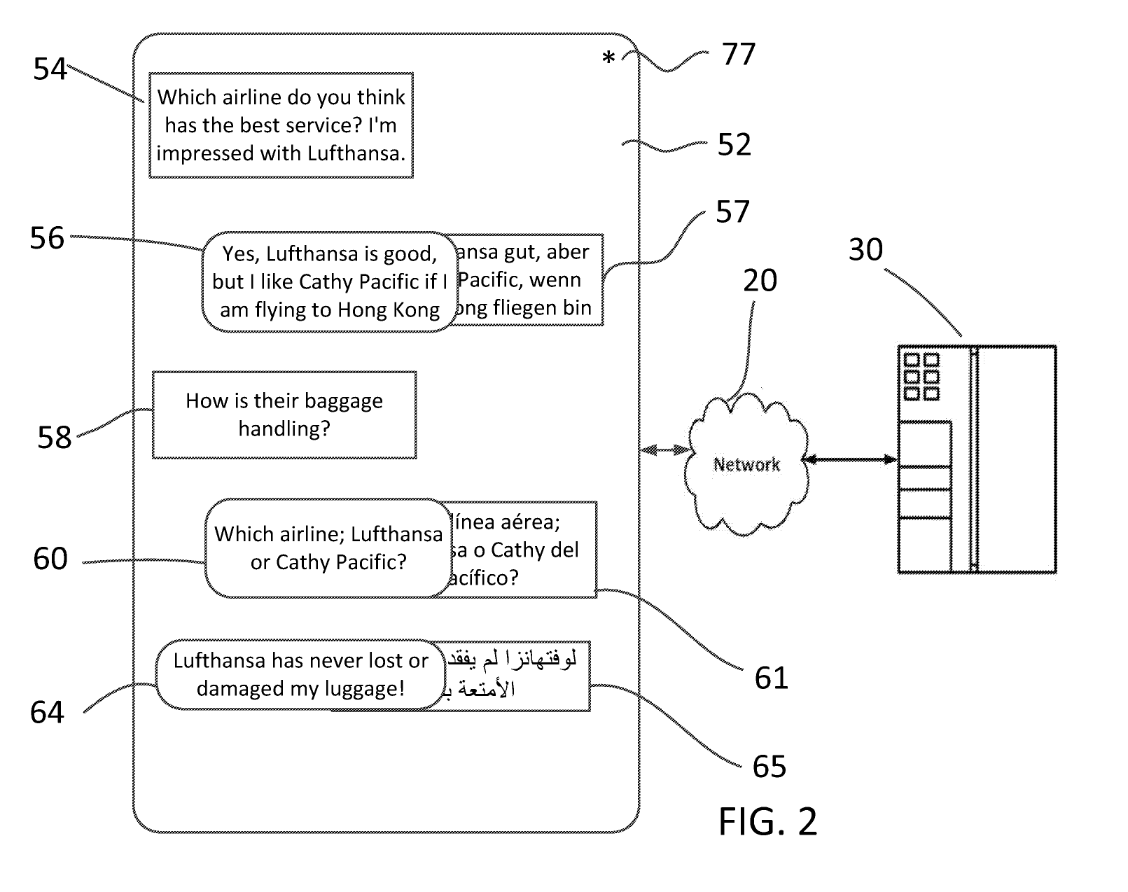

FIG. 2 illustrates an exemplary chat room web page in communication with a chat room server via a network. In some embodiments, as shown in the illustrative example, the chat room web page 52 is displaying the “chat room screen” text 54 and “chat room screen” text 56, 58, 60, 64. Underneath “chat room screen” text 56 is “chat room screen” text 57, which is the original non-translated text of “chat room screen” text 56. If the user prefers this to the translated version, then by clicking on it it will be on top and all subsequent text in that language will also be on top. “Chat room screen” text 61 is also the non-translated text of “chat room screen” text 60 and “chat room screen” text 65 is also the non-translated text of “chat room screen” text 64. Device 10 and server 30 communicate through wireless network 20. Speech-to-text icon 77 is chosen to convert the spoken word into text via software that is on the PC.

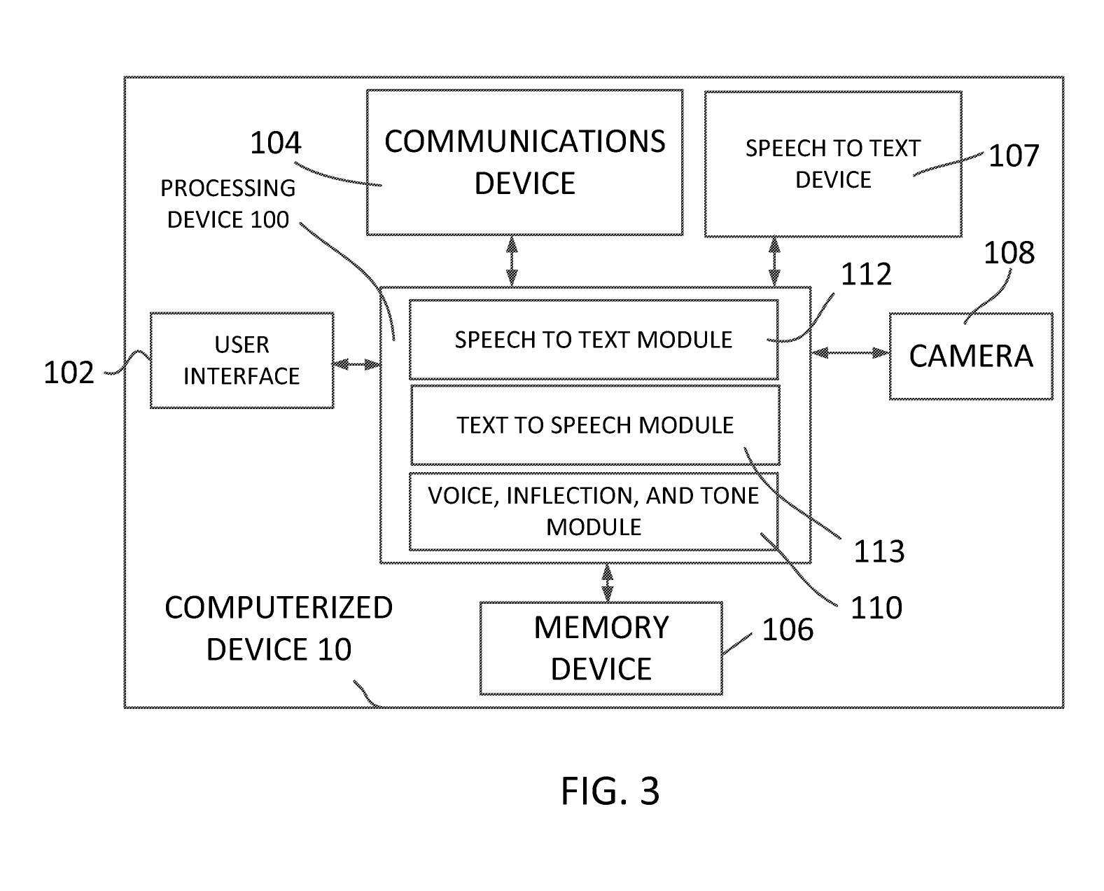

FIG. 3 is a schematic illustrating exemplary components of the portable computerized device of FIG. 1. In the illustrative embodiment, the portable computerized device 10 includes a processing device 100, a user interface 102, communication device 104, a memory device 106, a speech to text device 107, and a camera device 108. It is noted that the portable computerized device 10 can include other components and some of the components are not always required. While device 10 from FIGS. 1A and 1B are illustrated, any other embodiment of a computerized device can be similarly described with similar components.

The computerized devices of the present disclosure can include non-limiting examples of a desktop or laptop computer, a smart phone device, a tablet computer, a processor equipped pair of eyeglasses configured to project graphics upon a view of the wearer, or any other similar computerized device capable of operating the processes disclosed herein. Where not specifically referenced or disclosed, the disclosure intends that computerized functions, translations, database references, and other computerized tasks disclosed herein are performed using methods and programming practices known in the art.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the portable computerized device 10. In the illustrative embodiment, the processing device 100 also executes a voice, inflection, and tone module 110, a speech to text module 112, and a text to speech module 113, which are all described in greater detail herein.

In one embodiment, the voice, tone and inflection module 110 stores or includes functionality to reference online thousands of vocal tones and inflections that is then accessed by speech to text module 112 and text to speech module 113.

User interface 102 includes a device or devices that allows a user to interact with the portable computerized device 10. While one user interface 102 is shown, the term “user interface” can include, but is not limited to, a display, a touch screen, a physical keyboard, a mouse, a microphone, and/or a speaker. The communication device 104 is a device that allows the portable computerized device 10 to communicate with another device, e.g., chat room server 30, via the network 20.

The communication device 104 can include one or more wireless transceivers for performing wireless communication and/or one or more communication ports for performing wired communication.

The memory device 106 is a device that stores data generated or received by the portable computerized device 10. Memory device 106 can include, but is not limited to, a hard disc drive, an optical disc drive, and/or a flash memory drive. Online storage can alternatively or additionally be utilized.

The speech to text vocabulary device 107 can include a database of digitized vocabulary words, often the same word said with differing accents, so that when spoken, the speech to text module 112 can access this database and substitute text instead of an audio word. This database can also be used in reverse by the text to speech module to convert text back into audio by test to speech module 113.

The camera 108 can include a digital camera that captures a digital photograph, both still or video. Camera 108 can be used to send video of the user in real-time. One embodiment is when participating in an online discussion. While the video will be seen, the audio can be that of a computer generated translated voice. The digital photograph can be a bitmap, a JPEG, a GIF, or any other suitably formatted file. In one embodiment, camera 108 can be used to capture sign language as an input, and a relevant database and module can be provided for interpreting and translating sign language inputs.

The voice, inflection, and tone module 110 works in conjunction with text to speech module 113 and device 107. This module provides a more human quality to the audio sound, making it appear less mechanical and/or provides the user with an ability to select a desired voice for translated messages. Different audio qualities can be selected and stored for particular users or types of users with which the operator of the system interacts.

The text to speech module 113 interfaces with speech to text vocabulary device 107. It also includes programming to coordinate with server 30 to determine and display translated results as needed.

Speech to text module 112 also interfaces with speech to text vocabulary device 107. It also includes programming to coordinate with server 30 to determine and display translated results as needed. Speech to text module 112 can be presented according to a number of exemplary embodiments. In one embodiment, the software needed to perform the speech-to-text conversion is performed on server 30 via network 20.

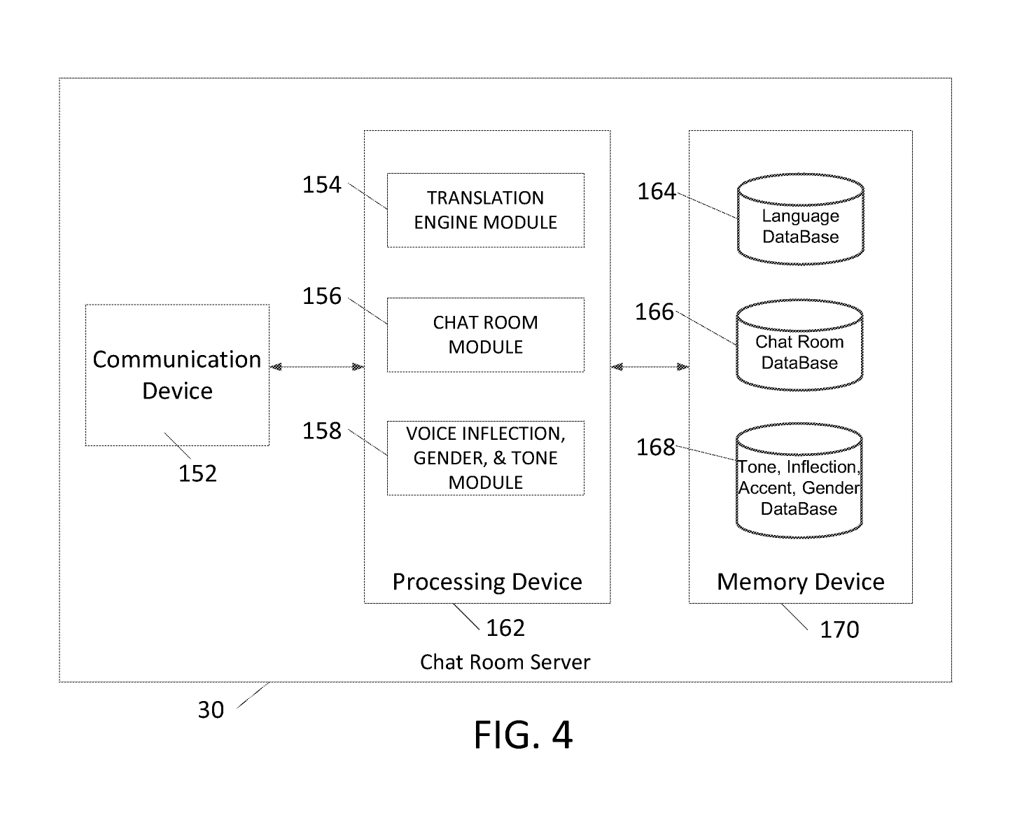

FIG. 4 is a schematic illustrating an exemplary chat room server, according to some embodiment of the disclosure. In the illustrated embodiment, the chat room server 30 may include a processing device 162, a communication device 152, and memory device 170. The processing device 162 can include memory, e.g., read only memory (ROM) and random access memory (RAM), storing processor-executable instructions and one or more processors that execute the processor-executable instructions. In embodiments where the processing device 162 includes two or more processors, the processors can operate in a parallel or distributed manner. In the illustrative embodiment, the processing device 162 executes one or more of a translation engine module 154, a chat room module 156, and voice tone, gender, inflection and inflection module 158.

The communication device 152 is a device that allows the server 30 to communicate with another device, e.g., a portable computerized device through a wireless communication network connection. The communication device 152 can include one or more wireless transceivers for performing wireless communication and/or one or more communication ports for performing wired communication.

Translation engine module 154 includes programming to translate information from one language to another language. Computerized methods known in the art such as are employed by Google® Translate can be employed within module 154 or made available by online reference through module 154, such that a word, phrase, or sentence in one language can be translated into a similar word, phrase, or sentence in a second language. As disclosed herein, syntax or other reference functions can be additionally included in a translation module.

Chat room module 156 employs computerized methods disclosed herein and methods known in the art to facilitate communication between different users. As disclosed herein, module 156 can use data, for example, made available through chat room database 166, to provide access to a portion of users using the server to discuss a particular topic or otherwise be segmented from the rest of the users. Chat room module 156 can include programming to generate visual decorative graphics for the users using a particular theme, for example, providing a particular display for users in a chat room discussing the World Cup.

Voice, inflection, gender, and tone module 158 can provide functionality related to translation or generation of communications for various languages, ethnicities, cultures, ages, gender, and other particularities that are required for communication between different population segments.

The memory device 170 is a device that stores data generated or the memory device 170 is a device that stores data generated or received by the server 30. The memory device 170 can include, but is not limited to a hard disc drive, an optical disc drive, and/or a flash memory drive. Further, the memory device 170 may be distributed and located at multiple locations. The memory device 170 is accessible to the processing device 162. In some embodiments, the memory device 170 includes a language database 164, a chat room database 166, and a tone, inflection, accent, gender database 168. Any resources available through memory device 170 can be similarly stored or referenced remotely through another server or as online resources that can be referenced according to methods known in the art.

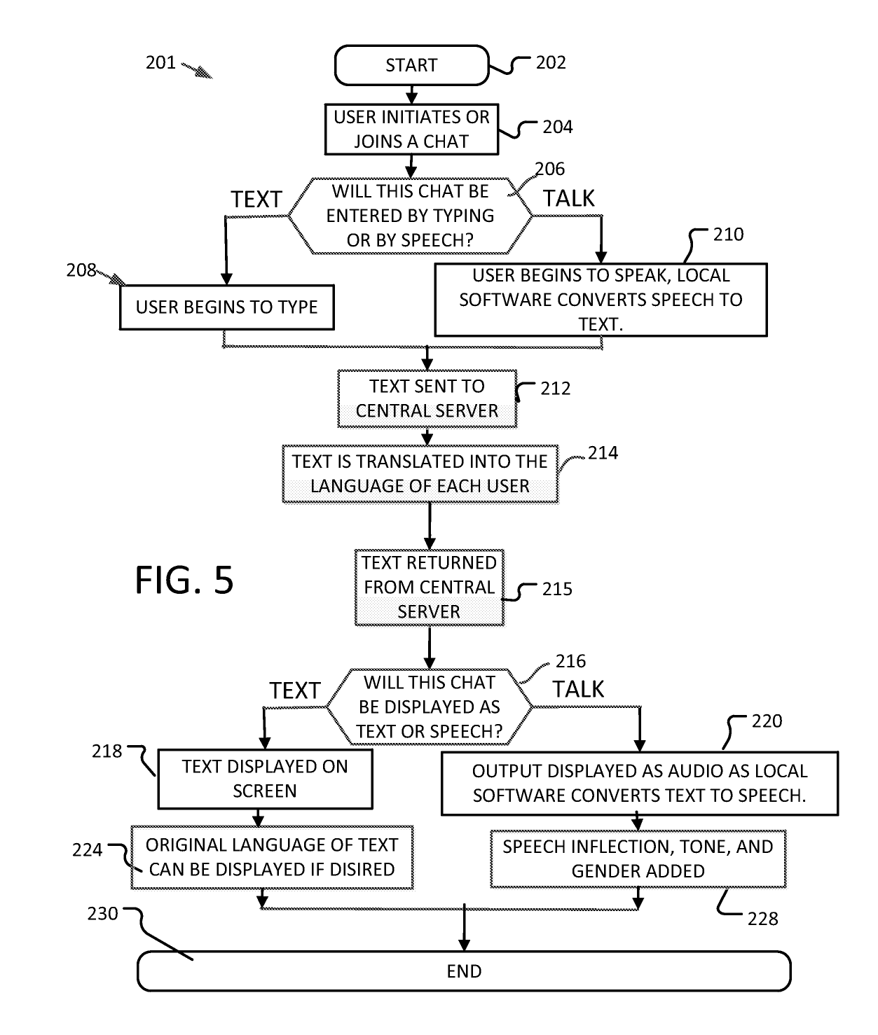

FIG. 5 illustrates a flowchart for exemplary processes for a user to join in an Internet chat room with multiple people who all speak different languages and still be able to all understand one another. Process 201 is illustrated. Embodiments in accordance with the present disclosure can include non-limiting examples of a smart phone device, a tablet computer, a desktop computer, a mainframe-based computer, a processor equipped pair of eyeglasses configured to project graphics upon a view of the wearer, or any other similar computerized device capable of operating the processes disclosed herein. Process 201 begins at step 202. At step 204, the user initiates or enters into an Internet chat room or on-line discussion forum. At step 206, the user decides if he or she prefers to enter messages by talking 210 or by typing 208. At step 212, the typed or speech to text is sent to a central server. At step 214, the server translates the text into the pre-chosen language of each user. At step 215, the text is returned from the central server. At step 216, the user has the option of listening to the replies and views of others of reading them as text. it will be appreciated that either or both text and/or audio outputs can be provided. Step 218 provides textual output. Step 224 provides an option for the user to view the translated message in the original language. If the user prefers, step 220 provides audio output and step 228 can provide for manipulation of the audio output as desired by the user. Process 201 ends at step 230. Process 201 is illustrated as a terminal process, however, it will be appreciated that process 201 can be operated iteratively and simultaneously for various communicative inputs for a provided chat or message exchange.

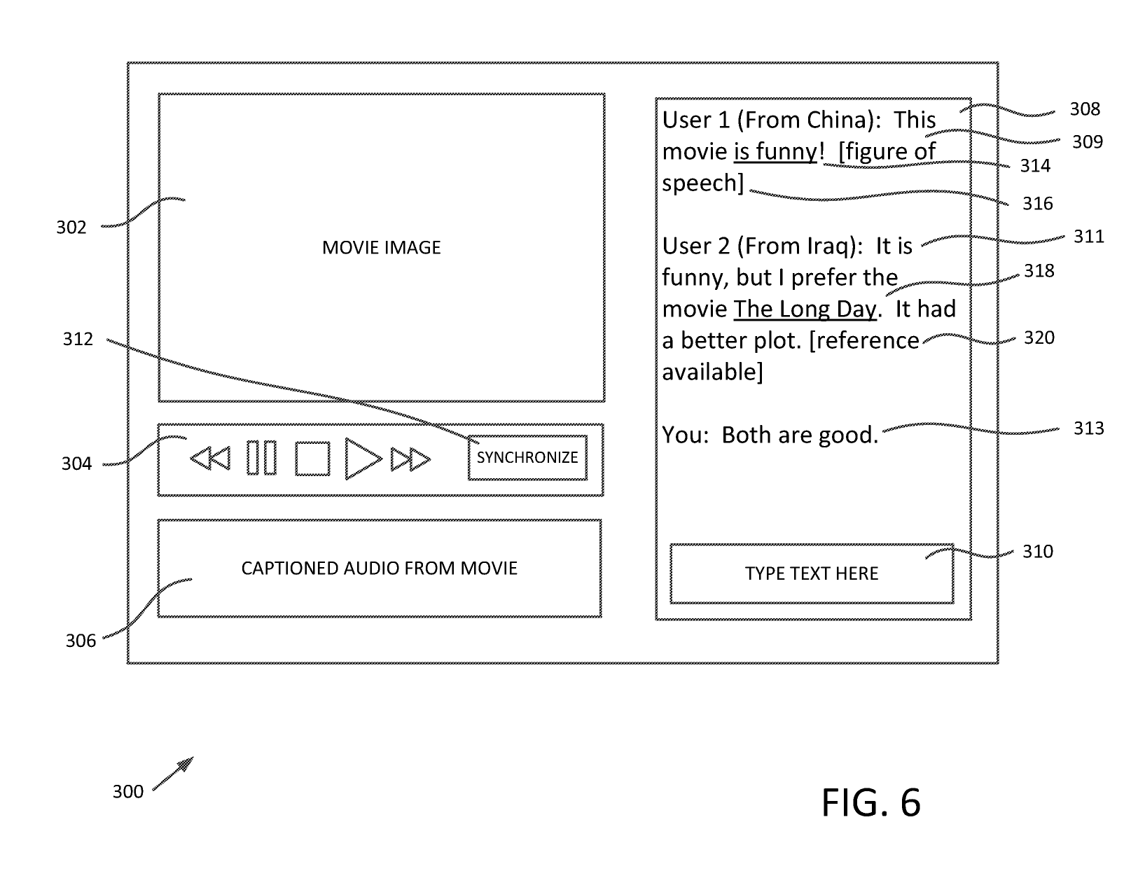

FIG. 6 illustrates an exemplary display screen providing a venue for a user to watch a synchronized display of a movie with other users, providing translated chat messages during the movie. Display 300 is provided, including movie viewing display portion 302, playback control display portion 304, movie caption display portion 306, and chat display portion 308. A similar display can be provided for other users located remotely from the user watching display 300. As the users are watching the synchronized movie, the users can share messages in chat display portion 308. Chat display portion 308 includes historical messages 309 from a first user in China, 311 from a second user in Iraq, and 313 from the user watching display 300. The user can enter new text messages by typing characters into text entry box 310, and this text is then displayed in portion 308 and similar portions for the other users. Each user can view the messages in their own selected language according to the system of the disclosure.

The movie displayed in portion 302 can be simply played for the viewer, and the display can be unalterably synchronized with the other users. Exemplary display 300 includes portion 304 permitting the user to either control playback for all of the users, for example, rewinding the movie for all of the users when one asks for it. In another embodiment, portion 304 permits a user to individually control the movie, for example, pausing the movie momentarily. Portion 304 includes a synchronize command button 312 so that the user can, if desired, immediately return to synchronous playback with the other users.

Chat display portion 308 includes historical message 309 which includes a syntax translation. The user that typed that message in his or her language used a figure of speech that the other users might not understand if directly translated. The disclosed system provides syntax translation text 314 and an indication 316 informing the user that a figure of speech was translated by the system. Text 314 can include a function such as a hyperlink function that could provide the original figure of speech and an ability to learn more about the figure of speech. Chat display portion 308 further includes historical message 311 which includes a title of another movie 318. The disclosed system can identify words or phrases that may be desirable as a reference that can be looked up by the user. Indication 320 is provided showing the user that a reference for the movie 318 is available. A number of display and playback options for providing a chat room related to a displayed video are envisioned, for example, including entertainment and educational functionality. The disclosure is not intended to be limited to the particular examples provided herein.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing device to function in a particular manner, such that the instructions stored in the computer-readable medium produce an article of manufacture including instruction means which implement the function/act specified in the flowchart and/or block diagram block or blocks.

Chat rooms can include themes. A program providing translation as disclosed herein can provide a framework for people of different cultures and nationalities to discuss subjects of common interests. For example, a program could present a number of themed chat rooms to users. Themes can include any of a number of topics and can include sub-themes. For example, a theme of sports could be presented to a user. Within that theme, a sub-theme of soccer/football can be offered. Within that sub-theme particular teams, particular tournaments, particular positions, particular skills, etc. could be presented for a chat room. In this way, an exemplary user from Argentina could discuss goalie tactics with another user from Iraq, with each user speaking in his native tongue, with other users from South Africa and the Netherlands listening to the conversation. The program could permit one of the users to link to third party website for an exemplary video of a goalie and could further permit the other user to upload an image of his play the previous week. Other non-limiting examples of themes can include entertainment, gardening, politics, religion, cooking, exercise, history, medicine, automotive interests, vacations and sightseeing, romance, and trivia.

A theme can be event driven. For example, a movie could be shown associated with a chat room, where every user can see the movie. Users can chat about the movie, and text, audio, or visual messages can be simultaneously translated and provided to all of the users watching the movie. Similarly, music can be transmitted, and users can simultaneously chat about the music. Similarly, an interactive online video game could be operated simultaneously with a chat room, such that users playing the game could chat during the game according to the methods disclosed herein. A number of embodiments of media that can be transmitted in conjunction with a chat room are envisioned, and the disclosure is not intended to be limited to the particular examples provided.

Translation between one language and another can include machine translation, such as is provided by widely available computerized services, translating one textual passage to another textual passage. However, such word-for-word translation can frequently be difficult to comprehend or leave a user confused as to the meaning of the other user. For example, a German-speaking user, wishing for an English-speaking user, may use the word “Bitte?” to ask the English-speaking user to repeat his last statement. This word translated directly means “Please?” However, using the syntax of the statement, a syntax database using common German language phrases and terms could translate the word into “Could you please say that again?” as would be commonly understood by German-speaking persons. Similarly, metaphors, similes, idioms, and other figures of speech could be stored in a syntax database to permit for automatic or manually-requested translations of a phrase. For example, a statement by a first user saying “They were like white to rice” could be translated by a syntax database to state “They were very close.”

Translations according to syntax could be performed automatically and without notification to the receiver of the communication that syntax translation was utilized. In another embodiment, reflecting an opportunity that such a program as is disclosed includes to educate and bring disparate groups together, the receiver could be given the option of additionally receiving both the machine translation and the translation provided by the syntax database. Such duplicate display of the message could help to educate and acclimate a user to the language customs of the other users. A syntax database could use locally stored terms and phrases to perform syntax translations. In another embodiment, the syntax database could alternatively or additionally make use of online resources to translate a word or phrase by syntax.

A user sending a message or a user receiving a message could similarly utilize a reference look-up function. Such a function could be performed by a reference database utilizing locally stored information or could access online resources to provide information related to a requested reference. For example, a person sending a message could type “I think that the [lookup: Detroit baseball team] sounds very interesting” in a first language. The translated message in a second language could include “I think that the Detroit Tigers sound very interesting.” The program can include programming to recognize the exemplary brackets and lookup prompt to include a request to fill in a term. In this way, barriers to communication such as lack of local knowledge can be reduced or eliminated. Similarly, if a user receiving a communication does not understand a term or wants to know more about it, a reference function can be provided. In one non-limiting exemplary embodiment, the program can permit a user to highlight or select a word and then prompt a reference function. A computerized window or alternate screen can be provided giving information about the highlighted word. For example, if a first user states that he is from Barcelona, Spain, a second user viewing the message of the first user can highlight “Barcelona, Spain” and a window providing a map and factual information about Barcelona can be provided.

In communications similar to chat room messaging, an online business can provide for communications between the company and consumers. According to one embodiment, the translation programming of the present disclosure can be utilized to streamline communications between a company and consumers. An agent of the company speaking one language and a consumer speaking a second language can communicate according to the disclosed system. Such computerized translation can reduce cost and improve customer satisfaction as compared to current practices which require extensive education of call center employees that must speak languages of other cultures and understand the customs of the other cultures sufficiently so as not to offend the consumers. A company practice database can be operated, similar to a syntax database disclosed herein, wherein communication can be filtered and modified to avoid misunderstandings. For example, an employee in a first language could state “What do you want?” Such a phrase, translated directly, could offend a consumer in a second language. The company could provide a translation in the company practice database to read “How may I be of assistance?” in the second language. Communication from the consumer to the employee can be similarly translated by the company practice database to avoid misunderstandings, flag certain words with inherent meaning, escalate requests to a supervisor when the tone of the consumer reaches a certain level of dissatisfaction, etc.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A system of communication, comprising:
a computerized processor operating a communication program, the program being configured to:
receive a first communication in a first language from a first user;
translate the first communication into a second language in real time;
provide the translated first communication to a second user;
receive a second communication in the second language from the second user;
translate the second communication into the first language in real time; and
provide the translated second communication to the first user.

2. The system of claim 1, wherein the program comprises a chat room program being further configured to provide for textual short message communication between a plurality of users.

3. The system of claim 1, wherein the program is further configured to provide communication between a company operating an online website and consumers.

4. The system of claim 3, wherein the program is further configured to provide company approved messaging to the consumers based upon input by an agent of the company.

5. The system of claim 1, wherein one of the communications comprises a textual message.

6. The system of claim 5, wherein the textual message comprises both textual data in both the first language and the second language.

7. The system of claim 1, wherein one of the communications comprises a voice message.

8. The system of claim 1, wherein one of the communications comprises a sign language message.

9. The system of claim 1, wherein the program is further configured to provide to a user a plurality of candidate chat rooms, each chat room including a selected topic of discussion.

10. The system of claim 1, wherein translating the first communication comprises a syntax conversion function.

11. The system of claim 1, wherein translating the first communication comprises a reference look-up function.

12. A computerized system of communication providing a chat room to a plurality of users, comprising:
a computerized processor operating a communication program, the program including programming to:
offer to each of the users a plurality of themed chat rooms for selection;
provide selected communication between a portion of the users based upon the selection of the themed chat rooms;
between the portion of the users, providing real-time translated communication, comprising:
receive a first communication in a first language from a first user;
translate the first communication into a second language in real time;
provide the translated first communication to a second user;
receive a second communication in the second language from the second user;
translate the second communication into the first language in real time; and
provide the translated second communication to the first user.

13. The system of claim 12, further comprising providing access to a recorded video to the portion of users.

14. The system of claim 13, wherein the access to the recorded video comprises simultaneous viewing of a movie.

15. The system of claim 12, further comprising providing access to an uploaded image to the portion of users.

16. The system of claim 12, wherein each of the plurality of themed chat rooms are directed to a theme comprising one of sports, entertainment, gardening, politics, religion, cooking, exercise, history, medicine, automotive interests, vacations, romance, and trivia.
